(19) United States
(12) Patent Application Publication
(10) Pub. No.: US 2004/0157158 A1
(43) Pub. Date: Aug. 12, 2004

(54) Optical recording medium

(75) Inventors: Hironori Kakiuchi, Tokyo (JP); Hiroyasu Inoue, Tokyo (JP)

Correspondence Address: SEED INTELLECTUAL PROPERTY LAW GROUP PLLC, 701 FIFTH AVE, SUITE 6300, SEATTLE, WA, 98104-7092, US

(73) Assignee: TDK Corporation, Tokyo (JP)

(21) Appl. No.: 10/764,805

(22) Filed: Jan. 26, 2004

(30) Foreign Application Priority Data
Jan. 28, 2003 (JP) 2003-19170

(51) Int. Cl. G11B 7/26

(52) U.S. Cl. 430/270.12; 369/284; 430/945

(57) ABSTRACT

An optical recording medium includes a substrate and a recording layer in which data can be recorded by projecting a laser beam thereonto, the recording layer including a first recording film containing an element selected from the group consisting of Si, Ge, Sn, Mg, In, Zn, Bi and Al as a primary component and a second recording film containing Cu as a primary component and 10 to 30 atomic % of Al as an additive.

The thus constituted optical recording medium has an excellent initial recording characteristic and can store recorded data in a good condition over the long term.

### BACKGROUND OF THE INVENTION

The present invention relates to an optical recording medium and, particularly, to an optical recording medium which has an excellent initial recording characteristic and can store recorded data in a good condition over the long term.

### DESCRIPTION OF THE PRIOR ART

Optical recording media such as the CD, DVD and the like have been widely used as recording media for recording digital data. These optical recording media can be roughly classified into optical recording media such as the CD-ROM and the DVD-ROM that do not enable writing and rewriting of data (ROM type optical recording media), optical recording media such as the CD-R and DVD-R that enable writing but not rewriting of data (write-once type optical recording media), and optical recording media such as the CD-RW and DVD-RW that enable rewriting of data (data rewritable type optical recording media).

Data are generally recorded in a ROM type optical recording medium using prepits formed in a substrate in the manufacturing process thereof, while in a data rewritable type optical recording medium a phase change material is generally used as the material of the recording layer and data are recorded utilizing changes in an optical characteristic caused by phase change of the phase change material.

On the other hand, in a write-once type optical recording medium, an organic dye such as a cyanine dye, phthalocyanine dye or azo dye is generally used as the material of the recording layer and data are recorded utilizing changes in an optical characteristic caused by chemical change of the organic dye, which change may be accompanied by physical deformation.

Unlike data recorded in a data rewritable type optical recording medium, data recorded in a write-once type optical recording medium cannot be erased and rewritten. This means that data recorded in a write-once type optical recording medium cannot be falsified, so that the write-once type optical recording medium is useful in the case where it is necessary to prevent data recorded in an optical recording medium from being falsified.

However, since an organic dye is degraded when exposed to sunlight or the like, it is difficult to improve long-time storage reliability in the case where an organic dye is used as the material of the recording layer. Therefore, it is desirable for improving long-time storage reliability of the write-once type optical recording medium to form the recording layer of a material other than an organic dye.

As disclosed in Japanese Patent Application Laid Open No. 62-204442, an optical recording medium formed by laminating two recording layers is known as an example of an optical recording medium whose recording layer is formed of a material other than an organic dye.

However, in the optical recording medium disclosed in Japanese Patent Application Laid Open No. 62-204442, it is difficult to store the initially recorded data in the recording layers in a good condition over the long term and since the surface smoothness of this optical recording medium is not necessarily good, the initial recording characteristic may be poor.

### SUMMARY OF THE INVENTION

It is therefore an object of the present invention to provide an optical recording medium which has an excellent initial recording characteristic and can store recorded data in a good condition over the long term.

The inventors of the present invention vigorously pursued a study for accomplishing the above object and, as a result, made the discovery that when a laser beam is used to record data in a recording layer composed of a first recording film containing an element selected from the group consisting of Si, Ge, Sn, Mg, In, Zn, Bi and Al as a primary component and a second recording film containing Cu as a primary component and 10 to 30 atomic % of Al as an additive, a record mark is formed by mixing both the primary component element of the first recording film and the primary component element of the second recording film to markedly change the reflection coefficient thereof and enable data to be recorded with high sensitivity. They the further discovered that data initially recorded with high sensitivity in the optical recording medium can be stored for a long time by utilizing the large difference in reflection coefficient between the region of the record mark including the primary component element of the first recording film and the primary component element of the second recording film, and the other regions and that jitter of a reproduced signal can be markedly decreased.

The present invention is based on this finding and according to the present invention, the above and other objects of the present invention can be accomplished by an optical recording medium comprising a substrate and a recording layer in which data can be recorded by projecting a laser beam thereonto, the recording layer including a first recording film containing an element selected from the group consisting of Si, Ge, Sn, Mg, In, Zn, Bi and Al as a primary component and a second recording film containing Cu as a primary component and 10 to 30 atomic % of Al as an additive.

In the present invention, the statement that the first recording film contains a certain element as a primary component means that the content of the element is maximum among the elements contained in the first recording film, while the statement that the second recording film contains Cu as a primary component means that the content of Cu is maximum among the elements contained in the second recording film.

In the present invention, it is not absolutely necessary for the second recording film to be in contact with the first recording film and it is sufficient for the second recording film to be so located in the vicinity of the first recording film as to enable formation of a mixed region including the primary component element of the first recording film and the primary component element of the second recording film, thereby forming a record mark when the region is irradiated with a laser beam. Further, one or more other layers such as a dielectric layer may be interposed between the first recording film and the second recording film.

In the present invention, it is preferable to form the second recording film so as to be in contact with the first recording film.

Although the reason why a mixed region including the primary component element of the first recording film and the primary component element of the second recording film can be formed, thereby forming a record mark when irradiated with a laser beam is not altogether clear, it is reasonable to conclude that the primary component elements of the first and second recording films are partially or totally fused or diffused, thereby forming a region where the primary component elements of the first and second recording films mix.

The reflection coefficient that the record mark thus formed by mixing the primary component elements of the first and second recording films exhibits with respect to a laser beam for reproducing information and the reflection coefficient that other regions exhibit with respect to the laser beam for reproducing information are considerably different and, therefore, recorded information can be reproduced with high sensitivity by utilizing such large difference in the reflection coefficients.

In the present invention, it is necessary for the second recording film to contain 10 to 30 atomic % of Al.

In the case where the content of Al in the second recording film is less than 10 atomic % or exceeds 30 atomic %, jitter of a reproduced signal becomes worse and, further, in the case where the content of Al in the second recording film is less than 10 atomic %, the storage reliability of the optical recording medium becomes worse.

In the present invention, the second recording film preferably contains 10 to 25 atomic % of Al and more preferably contains 20 to 25 atomic % of Al.

In the case where the content of Al of the second recording film is equal to or less than 25 atomic %, it is possible to improve the recording sensitivity and in the case where the content of Al in the second recording film is 20 to 25 atomic %, it is possible to markedly reduce jitter of a reproduced signal. Further, since it is possible to further improve the recording sensitivity in the case where the content of Al in the second recording film is equal to or less than 20 atomic %, it is most preferable for the second recording film to contain about 20 atomic % of Al.

In a preferred aspect of the present invention, the optical recording medium further comprises a first dielectric layer and a second dielectric layer on the both sides of the recording layer.

In a preferred aspect of the present invention, the optical recording medium further comprises a light transmission layer having a thickness of 10 to 300 μm on the opposite side to the substrate with respect to the recording layer and one surface of the light transmission layer constitutes a light incidence plane through which the laser beam enters the optical recording medium.

In the present invention, a laser beam preferably has a wavelength of 380 nm to 450 nm in order to obtain high modulation.

The above and other objects of the present invention can be also accomplished by an optical recording medium comprising a substrate and a plurality of information record layers in which data can be recorded by projecting a laser beam thereonto, at least one information recording layer other than a information recording layer farthest from a light incidence plane through which a laser beam enters including a first recording film containing an element selected from the group consisting of Si, Ge, Sn, Mg, In, Zn, Bi and Al as a primary component and a second recording film containing Cu as a primary component and 10 to 30 atomic % of Al as an additive.

According to the present invention, when a laser beam is used to record data in the at least one information recording other than a information recording layer farthest from the light incidence plane, since the element contained in the first recording film as a primary component and the element contained in the second recording film as a primary component are mixed to form a record mark and the reflection coefficient of the record mark is greatly different from those of regions where no record mark is formed, data can be recorded in the at least one information recording other than a information recording layer farthest from the light incidence plane with high sensitivity and data initially recorded with high sensitivity in the optical recording medium can be stored for a long time. Further, jitter of a reproduced signal can be markedly decreased.

Further, in the case of recording data in a farthest information recording layer from the light incidence plane and reproducing data from the farthest information recording layer, the amount of a laser beam projected onto the farthest information recording layer and the amount of the laser beam reflected by the farthest information recording layer and detected are influenced by information recording layers other than the farthest information recording layer. Accordingly, in the case where the light transmittance of a region of an information recording layer other than the farthest information recording layer where a record mark is formed and that of a blank region of the information recording layer other than the farthest information recording layer where no record mark is formed are greatly different from each other, when data are recorded in the farthest information recording layer and data recorded in the farthest information recording layer are reproduced by adjusting the focus of a laser beam on the farthest information recording layer and irradiating the farthest information recording layer with the laser beam, the amount of the laser beam projected onto the farthest information recording layer and the amount of the laser beam reflected by the farthest information recording layer and detected differ greatly depending upon whether the region of the information recording layer other than the farthest information recording layer through which the laser beam is projected is a region where a record mark is formed or a blank region. As a result, the recording characteristics of the farthest information recording layer and the amplitude of a signal reproduced from the farthest information recording layer change greatly depending upon whether the region of the information recording layer other than the farthest information recording layer through which the laser beam is projected is a region where a record mark is formed or a blank region. However, in a study done by the inventors of the present invention, it was found that when the at least one information recording layer was irradiated with a laser beam, the difference in light transmittances between a region where a record mark was formed by mixing, an element selected from the group consisting of Si, Ge, Sn, Mg, In, Zn, Bi and Al and contained in the first recording film as a primary component and Cu contained in the second recording film as a primary component, and a blank region was small, and therefore, in the case of recording data in the farthest information recording layer from the light incidence plane or reproducing data from the farthest information recording layer by projecting a laser beam onto the farthest information recording layer via the at least one information recording layer, even if a region of the recording layer through which the laser beam is transmitted contains a region where a record mark is formed and a blank region, it is possible to record data in the farthest information recording layer from the light incidence plane and reproduce data from the farthest recording layer in a desired manner.

Since the difference in light transmittances between a region where a record mark is formed by mixing an element contained in the first recording film as a primary component and an element contained in the second recording film as a primary component and a blank region is particularly small with respect to a laser beam having a wavelength of 380 nm to 450 nm, in the present invention, it is preferable for a laser beam projected onto the plurality of information recording layers to have a wavelength of 380 nm to 450 nm.

The above and other objects and features of the present invention will become apparent from the following description made with reference to the accompanying drawings.

### BRIEF DESCRIPTION OF THE DRAWINGS

FIG. 1 is a schematic perspective view showing an optical recording medium that is a preferred embodiment of the present invention.

FIG. 2 is an enlarged schematic cross-sectional view of the part of the optical recording medium indicated by A in FIG. 1.

FIG. 3 is a schematic enlarged cross-sectional view showing an optical recording medium shown in FIGS. 1 and 2 after a recording layer was irradiated with a laser beam.

FIG. 4 is a diagram showing the waveform of a pulse train pattern for modulating the power of a laser beam in the case of recording 2T signals in a recording layer of an optical recording medium shown in FIGS. 1 and 2.

FIG. 5 is a diagram showing the waveform of a pulse train pattern for modulating the power of a laser beam in the case of recording 3T signals in a recording layer of an optical recording medium shown in FIGS. 1 and 2.

FIG. 6 is a diagram showing the waveform of a pulse train pattern for modulating the power of a laser beam in the case of recording 4T signals in a recording layer of an optical recording medium shown in FIGS. 1 and 2.

FIG. 7 is a diagram showing the waveform of a pulse pattern for modulating the power of a laser beam in the case of recording one among a 5T signal to an 8T signal in a recording layer of an optical recording medium shown in FIGS. 1 and 2.

FIG. 8 is a partially enlarged schematic cross-sectional view showing an optical recording medium that is another preferred embodiment of the present invention.

FIG. 9 is a schematic enlarged cross-sectional view showing details of an L0 information recording layer.

FIG. 10 is a schematic enlarged cross-sectional view showing details of an L1 information recording layer.

FIG. 11 is a schematic enlarged cross-sectional view showing an optical recording medium shown in FIG. 8 after an L0 information recording layer was irradiated with a laser beam.

FIG. 12 is a schematic enlarged cross-sectional view showing an optical recording medium shown in FIG. 8 after an L1 information recording layer was irradiated with a laser beam.

FIG. 13 is a diagram showing the waveform of a pulse train pattern for modulating the power of a laser beam in the case of recording 2T signals in an L1 information recording layer of an optical recording medium shown in FIG. 8.

FIG. 14 is a diagram showing the waveform of a pulse train pattern for modulating the power of a laser beam in the case of recording 3T signals in an L1 information recording layer of an optical recording medium shown in FIG. 8.

FIG. 15 is a diagram showing the waveform of a pulse train pattern for modulating the power of a laser beam in the case of recording 4T signals in an L1 information recording layer of an optical recording medium shown in FIG. 8.

FIG. 16 is a diagram showing the waveform of a pulse pattern for modulating the power of a laser beam in the case of recording one among a 5T signal to an 8T signal in an L1 information recording layer of an optical recording medium shown in FIG. 8.

FIG. 17 is a graph showing how jitter of a reproduced signal and an optimum recording power of a laser beam varied with an amount of Al added to a second recording film in Working Example 1.

FIG. 18 is a graph showing how light transmittances of optical recording medium samples #1 to #11 varied with an amount of Al added to a second recording film in Working Example 2.

### DESCRIPTION OF THE PREFERRED EMBODIMENTS

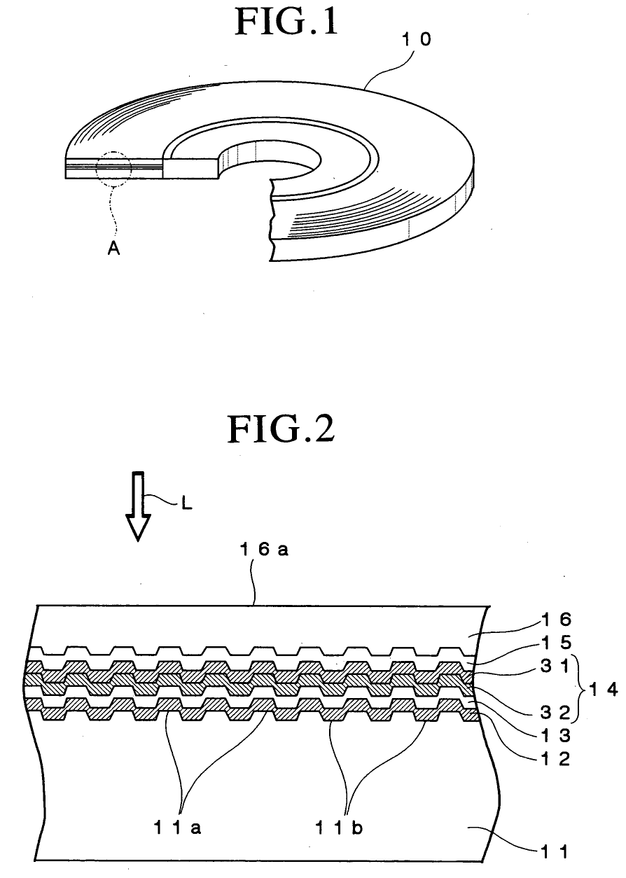

FIG. 1 is a schematic perspective view showing an optical recording medium that is a preferred embodiment of the present invention and FIG. 2 is a schematic enlarged cross-sectional view indicated by A in FIG. 1.

As shown in FIG. 1, an optical recording medium 10 according to this embodiment is formed disk-like and has an outer diameter of about 120 mm and a thickness of about 1.2 mm.

An optical recording medium 10 according to this embodiment is constituted as a write-once type optical recording medium and as shown in FIG. 2, it includes a support substrate 11, a reflective layer 12 formed on the surface of the support substrate 11, a second dielectric layer 13 formed on the surface of the reflective layer 12, a recording layer 14 formed on the surface of the second dielectric layer 13, a first dielectric layer 15 formed on the surface of the recording layer 14 and a light transmission layer 16 formed on the surface of the first dielectric layer 15.

In this embodiment, as shown in FIG. 1, a laser beam L having a wavelength of 380 nm to 450 nm is projected onto a light incidence plane 16a constituted by one surface of the light transmission layer 16, thereby recording data in the optical recording medium 10 or reproducing data from the optical recording medium 10.

The support substrate 11 serves as a support for ensuring mechanical strength and a thickness of about 1.2 mm required for the optical recording medium 10.

The material used to form the support substrate 11 is not particularly limited insofar as the support substrate 11 can serve as the support of the optical recording medium 10. The support substrate 11 can be formed of glass, ceramic, resin or the like. Among these, resin is preferably used for forming the support substrate 11 since resin can be easily shaped. Illustrative examples of resins suitable for forming the support substrate 11 include polycarbonate resin, polyolefin resin, acrylic resin, epoxy resin, polystyrene resin, polyethylene resin, polypropylene resin, silicone resin, fluoropolymers, acrylonitrile butadiene styrene resin, urethane resin and the like. Among these, polycarbonate resin and polyolefin resin are most preferably used for forming the support substrate 11 from the viewpoint of easy processing, optical characteristics and the like and in this embodiment, the support substrate 11 is formed of polycarbonate resin. In this embodiment, since the laser beam L is projected via the light incident plane 16a located opposite to the support substrate 11, it is unnecessary for the support substrate 11 to have a light transmittance property.

As shown in FIG. 2, grooves 11a and lands 11b are alternately and spirally formed on the surface of the support substrate 11 so as to extend from a portion in the vicinity of the center of the support substrate 11 toward the outer circumference. The grooves 11a and/or lands 11b serve as a guide track for the laser beam L.

The depth of the groove 11a is not particularly limited and is preferably set to 10 nm to 40 nm. The pitch of the grooves 11a is not particularly limited and is preferably set to 0.2 μm to 0.4 μm.

It is preferable to form the support substrate 11 by an injection molding process using a stamper but the support substrate 11 may instead be formed using another process such as the 2P process.

The reflective layer 12 serves to reflect the laser beam L10 entering through the light transmission layer 16 so as to emit it from the light transmission layer 16.

The material used to form the reflective layer 12 is not particularly limited insofar as it can reflect a laser beam, and the reflective layer 12 can be formed of Mg, Al, Ti, Cr, Fe, Co, Ni, Cu, Zn, Ge, Ag, Pt, Au and the like. Among these materials, it is preferable to form the reflective layer 12 of a metal material having a high reflection characteristic, such as Al, Au, Ag, Cu or alloy containing at least one of these metals, such as alloy of Al and Ti.

The thickness of the reflective layer 12 is not particularly limited but is preferably from 5 nm to 300 nm, more preferably from 20 nm to 200 nm.

In the case where the thickness of the reflective layer 12 is thinner than 5 nm, it is difficult to reflect a laser beam L in a desired manner. On the other hand, in the case where the thickness of the reflective layer 12 exceeds 300 nm, the surface smoothness of the reflective layer 12 becomes worse and it takes a longer time for forming the reflective layer 12, thereby lowering the productivity of the optical recording medium 10.

The first dielectric layer 15 and the second dielectric layer 13 serve to protect the recording layer 14. Degradation of optically recorded data can be prevented over a long period by the first dielectric layer 15 and the second dielectric layer 13.

The material for forming the first dielectric layer 15 and the second dielectric layer 13 is not particularly limited insofar as it is transparent in the wavelength range of the laser beam L and the first dielectric layer 15 and the second dielectric layer 13 can be formed of a dielectric material containing oxide, sulfide, nitride, carbide or a combination thereof, for example, as a primary component. In order to prevent the support substrate 11 from being deformed by heat and improve the characteristics of the first dielectric layer 15 and the second dielectric layer 13 for protecting the recording layer 14, it is preferable to form the first dielectric layer 15 and the second dielectric layer 13 of an oxide, sulfide, nitride or carbide of Al, Si, Ce, Ti, Zn, Ta or the like, such as Al₂O₃, AlN, ZnO, ZnS, GeN, GeCrN, CeO₂, SiO, SiO₂, Si₃N₄, SiC, La₂O₃, TaO, TiO₂, SiAlON (mixture of SiO₂, Al₂O₃, Si₃N₄ and AlN), LaSiON (mixture of La₂O₃, SiO₂ and Si₃N) or the like, or the mixture thereof, and it is particularly preferable to form the first dielectric layer 15 and the second dielectric layer 13 of a mixture of ZnS and SiO₂. In the case where the first dielectric layer 15 and the second dielectric layer 13 are formed of the mixture of ZnS and SiO₂, the mole ratio of ZnS to SiO₂ is preferably 80:20.

The first dielectric layer 15 and the second dielectric layer 13 may be formed of the same dielectric material or of different dielectric materials. Moreover, at least one of the first dielectric layer 15 and the second dielectric layer 13 may have a multi-layered structure including a plurality of dielectric films.

The thickness of the first dielectric layer 15 and the second dielectric layer 13 is not particularly limited but is preferably from 3 nm to 200 nm. If the first dielectric layer 15 or the second dielectric layer 13 is thinner than 3 nm, it is difficult to obtain the above-described advantages. On the other hand, if the first dielectric layer 15 or the second dielectric layer 13 is thicker than 200 nm, it takes a long time to form the first dielectric layers 15 and the second dielectric layers 13, thereby lowering the productivity of the optical recording medium 10, and cracks may be generated in the optical recording medium 10 owing to stress present in the first dielectric layers 15 and/or the second dielectric layer 13.

The first dielectric layer 15 and the second dielectric layer 13 also serve to increase the difference in optical properties of the optical recording medium 10 between before and after data recording and it is therefore preferable to form the first dielectric layer 15 and the second dielectric layer 13 of a material having a high refractive index n in the wavelength range of the laser beam L. Further, since the recording sensitivity becomes low as the energy absorbed in the first dielectric layer 15 and the second dielectric layer 13 becomes large when the laser beam L is projected onto the optical recording medium 10 and data are to be recorded therein, it is preferable to form the first dielectric layer 15 and the second dielectric layer 13 of a material having a low extinction coefficient k in the wavelength range of the laser beam L.

The recording layer 14 is adapted for recording data therein and as shown in FIG. 2, the recording layer 14 is constituted by laminating a first recording film 31 and a second recording film 32.

As shown in FIG. 2, in this embodiment, the first recording film 31 is disposed on the side of the light transmission layer 16 and the second recording film 32 is disposed on the side of the support substrate 11.

In this embodiment, the first recording film 31 contains Si as a primary component and the second recording film 32 contains Cu as a primary component and 10 to 30 atomic % of Al as an additive.

In the case where Al is added to the second recording film 32 containing Cu as a primary component, jitter of a reproduced signal can be reduced. However, in the case where the content of Al in the second recording film is less than 10 atomic % or exceeds 30 atomic %, jitter of a reproduced signal becomes worse and, further, in the case where the content of Al in the second recording film is less than 10 atomic %, the storage reliability of the optical recording medium becomes worse.

The second recording film 32 is preferably added with 10 to 25 atomic % of Al and more preferably added with 20 to 25 atomic % of Al.

It is preferable for the second recording film 32 to contain no element other than Cu and Al but the second recording film 32 may contain 1 atomic % or less of other elements than Cu and Al as impurities.

The surface smoothness of the first recording film 31 irradiated with the laser beam L10 becomes worse as the total thickness of the first recording film 31 and the second recording film 32 becomes thicker. As a result, the noise level of the reproduced signal becomes higher and the recording sensitivity is lowered. Therefore, it is preferable to form the total thickness of the first recording film 31 and the second recording film 32 thinner in order to prevent the surface smoothness of the first recording film 31 from becoming worse but in the case where the total thickness of the first recording film 31 and the second recording film 32 is too small, the change in reflection coefficient between before and after irradiation with the laser beam L10 is small, so that a reproduced signal having high strength (C/N ratio) cannot be obtained. Moreover, it becomes difficult to control the thickness of the first recording film 31 and the second recording film 32.

Therefore, in this embodiment, the first recording film 31 and the second recording film 32 are formed so that the total thickness thereof is from 2 nm to 40 nm. In order to obtain a reproduced signal having higher strength (C/N ratio) and further decrease the noise level of the reproduced signal, the total thickness of the first recording film 31 and the second recording film 32 is preferably from 2 nm to 20 nm and more preferably 2 nm to 15 nm.

The individual thicknesses of the first recording film 31 and the second recording film 32 are not particularly limited but in order to considerably improve the recording sensitivity and greatly increase the change in reflection coefficient between before and after irradiation with the laser beam L, the thickness of the first recording film 31 is preferably from 1 nm to 30 nm and the thickness of the second recording film 32 is preferably from 1 nm to 30 nm. Further, it is preferable to define the ratio of the thickness of the first recording film 31 to the thickness of the second recording film 32 (thickness of first recording film 31/thickness of second recording film 32) to be from 0.2 to 5.0.

Each of the reflective layer 12, the second dielectric layer 13, the second recording film 32, the first recording film 31 and the first dielectric layer 15 can be formed using a gas phase growth process using chemical species containing elements for forming it. Illustrative examples of the gas phase growth processes include vacuum deposition (vacuum evaporation) process, sputtering process and the like but it is preferable to use the sputtering process.

The light transmission layer 16 serves to transmit a laser beam L and preferably has a thickness of 10 μm to 300 μm. More preferably, the light transmission layer 16 has a thickness of 50 μm to 150 μm.

The material used to form the light transmission layer 16 is not particularly limited but in the case where the light transmission layer 16 is to be formed by the spin coating process or the like, ultraviolet ray curable resin, electron beam curable resin or the like is preferably used. More preferably, the light transmission layer 16 is formed of acrylic ultraviolet ray curable resin or epoxy ultraviolet ray curable resin.

The light transmission layer 16 may be formed by adhering a sheet made of light transmittable resin to the surface of the first dielectric layer 15 using an adhesive agent.

Data are recorded in the optical recording medium 10 of the above-described configuration, in the following manner, for example.

As shown in FIG. 1, the recording layer 14 is first irradiated via the light transmission layer 16 with a laser beam L having predetermined power.

In order to record data with high recording density, it is preferable to project a laser beam L having a wavelength of 380 nm to 450 nm onto the optical recording medium 10 via an objective lens (not shown) having a numerical aperture NA of 0.7 or more.

In this embodiment, a laser beam L having a wavelength λ of 405 nm is projected onto the optical recording medium 10 via an objective lens having a numerical aperture NA of 0.85.

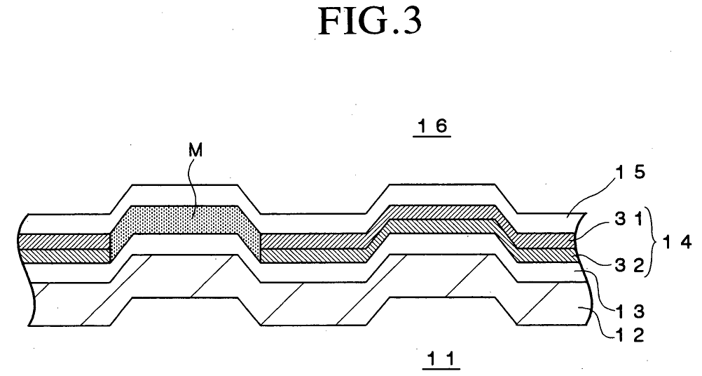

As shown in FIG. 3, this results in formation at the region of the recording layer 14 irradiated with the laser beam L of a record mark M composed of a mixture of the primary component element of the first recording film 31 and the primary component element of the second recording film 32, thereby recording data in the optical recording medium 10.

When the record mark M is formed by mixing the element contained in the first recording film 31 as a primary component and the element contained in the second recording film 32 as a primary component, the reflection coefficient of the region where the record mark M is formed markedly changes. Since the reflection coefficient of the region where the record mark M is thus formed is therefore greatly different from that of the region surrounding the region of the record mark M, it is possible to record data with high sensitivity and store data initially recorded with high sensitivity for a long time. Further, it is possible to obtain a high reproduced signal (C/N ratio) when recorded data are reproduced.

Moreover, in this embodiment, since 10 to 30 atomic % of Al is added to the second recording film 32 containing Cu as a primary component, jitter of a reproduced signal can be decreased.

Furthermore, in this embodiment, since Si contained in the first recording film 31 as a primary component and Cu contained in the second recording film 32 as a primary component are ordinary elements present in the natural environment, there is no risk of harm to the global environment.

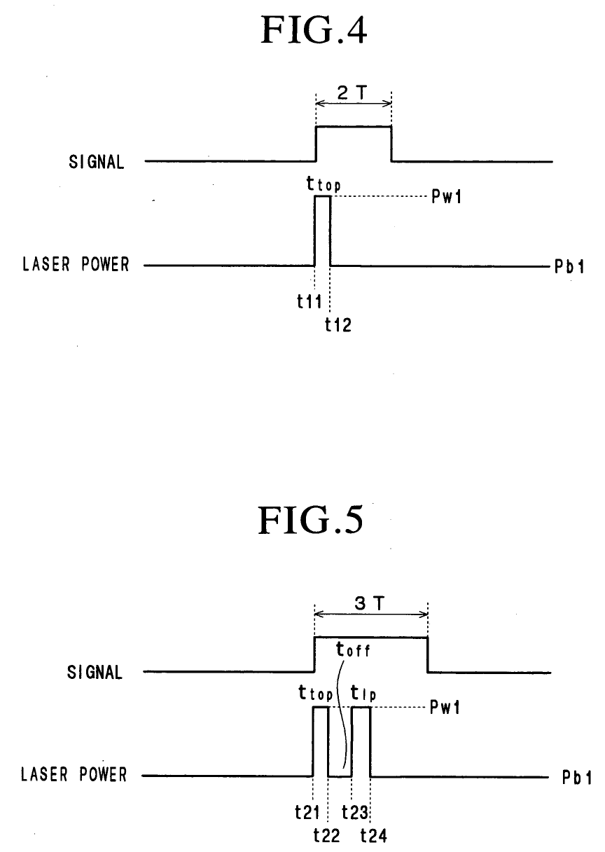

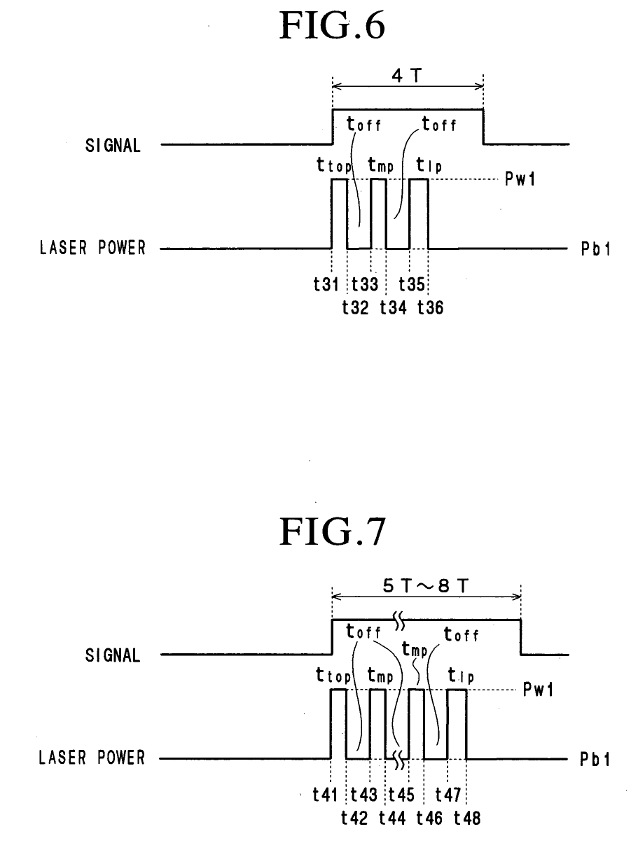

Each of FIGS. 4 to 7 is a diagram showing the waveform of a pulse pattern for modulating the power of the laser beam L in the case of recording data in the recording layer 14 of the optical recording medium 10, where FIG. 4 shows a pulse train pattern used in the case of recording 2T signals, FIG. 5 shows a pulse train pattern used in the case of recording 3T signals, FIG. 6 shows a pulse train pattern used in the case of recording 4T signals and FIG. 7 shows a pulse train pattern used in the case of recording one among a 5T signal to an 8T signal.

As shown in FIGS. 4 to 7, the power of the laser beam L is modulated between two levels, a recording power Pw1 and a ground power Pb1 where Pw1>Pb1.

The recording power Pw1 is set to such a high level that Si contained in the first recording film 31 as a primary component and Cu contained in the second recording film 32 as a primary component can be heated and mixed to form a record mark M when the laser beam L whose power is set to the recording power Pw1 is projected onto the recording layer 14. On the other hand, the ground power Pb1 is set to such an extremely low level that regions of the recording layer 14 heated by irradiation with the laser beam L whose power is set to the recording power Pw1 can be cooled by irradiation with the laser beam L whose power is set to the ground power Pb1.

As shown in FIG. 4, in the case of recording 2T signals in the recording layer 14 of the optical recording medium 10, the power of the laser beam L is modulated so that it is increased from the ground power Pb1 to the recording power Pw at the time t11 and decreased from the recording power Pw to the ground power Ph at the time t12 after passage of a predetermined time period tₜₒₚ.

On the other hand, as shown in FIG. 5, in the case of recording 3T signals in the recording layer 14 of the optical recording medium 10, the power of the laser beam L is modulated so that it is increased from the ground power Pb1 to the recording power Pw1 at the time t21, decreased from the recording power Pw1 to the ground power Pb1 at the time t22 after passage of a predetermined time period tₜₒₚ, increased from the ground power Pb1 to the recording power Pw1 at the time t23 after passage of a predetermined time period t_{off} and decreased from the recording power Pw1 to the ground power Pb1 at the time t24 after passage of a predetermined time period tₗₚ.

Further, as shown in FIG. 6, in the case of recording 4T signals in the recording layer 14 of the optical recording medium 10, the power of the laser beam L is modulated so that it is increased from the ground power Pb to the recording power Pw at the time t31, decreased from the recording power Pw to the ground power Ph at the time t32 after passage of a predetermined time period tₜₒₚ, increased from the ground power Pb to the recording power Pw aat the time t33 after passage of a predetermined time period t_{off}, decreased from the recording power Pw to the ground power Pb at the time t34 after passage of a predetermined time period tₘₚ, increased from the ground power Pb to the recording power Pw at the time t35 after passage of a predetermined time period t_{off} and decreased from the recording power Pw to the ground power Pb at the time t36 after passage of a predetermined time period tₗₚ.

Moreover, as shown in FIG. 7, in the case of recording one among a 5T signal to a 8T signal in the recording layer 14 of the optical recording medium 10, the power of the laser beam L is modulated so that it is increased from the ground power Pb1 to the recording power Pw1, held at the recording power Pw1 during the time period tₜₒₚ, the time periods tₘₚ and the time period tₗₚ, held at the ground power Pb during the time periods t_{off} and decreased from the recording power Pw1 to the ground power Pb at the time t48.

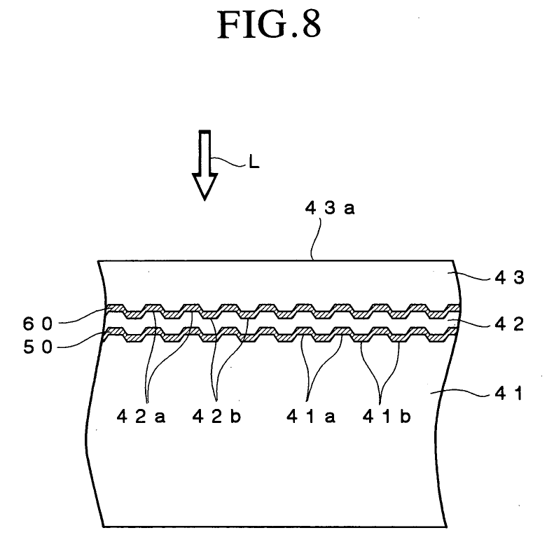

FIG. 8 is a partially enlarged schematic cross-sectional view showing an optical recording medium that is another preferred embodiment of the present invention.

Similarly to the optical recording medium 10 shown in FIG. 1, an optical recording medium 40 according to this embodiment is formed disk-like and has an outer diameter of about 120 mm and a thickness of about 1.2 mm.

As shown in FIG. 8, the optical recording medium 40 according to this embodiment includes a support substrate 41, a transparent intermediate layer 42, a light transmission layer 43, an L0 information recording layer 50 formed between the support substrate 41 and the transparent intermediate layer 42, and an L1 information recording layer 60 formed between the transparent intermediate layer 42 and the light transmission layer 43, and a light incidence plane 43a through which a laser beam L enters is constituted by one surface of the light transmission layer 43.

The L0 information recording layer 50 constitutes an information recording layer far from the light incidence plane 43a and the L1 information recording layer 60 constitutes an information recording layer close to the light incidence plane 43a.

The support substrate 41 is formed similarly to the support substrate 11 of the optical recording medium 10, and as shown in FIG. 8, grooves 41a and lands 41b are formed on the surface thereof. The grooves 41a and/or lands 41b serve as a guide track for the laser beam L when data are to be recorded in or data are to be reproduced from the L0 information recording layer 50.

The transparent intermediate layer 42 serves to space the L0 information recording layer 50 and the L1 information recording layer 60 apart by a physically and optically sufficient distance.

As shown in FIG. 8, grooves 42a and lands 42b are formed on the surface of the transparent intermediate layer 42. The grooves 42a and/or lands 42b serve as a guide track for the laser beam L when data are to be recorded in or data are to be reproduced from the L1 information recording layer 60.

The material for forming the transparent intermediate layer 42 is not particularly limited and an ultraviolet ray curable acrylic resin is preferably used for forming the transparent intermediate layer 42.

It is necessary for the transparent intermediate layer 42 to have sufficiently high light transmittance since the laser beam L passes through the transparent intermediate layer 42 when data are to be recorded in the L0 information recording layer 50 and data recorded in the L0 information recording layer 50 are to be reproduced.

The light transmission layer 43 is formed similarly to the light transmission layer 16 of the optical recording medium 10.

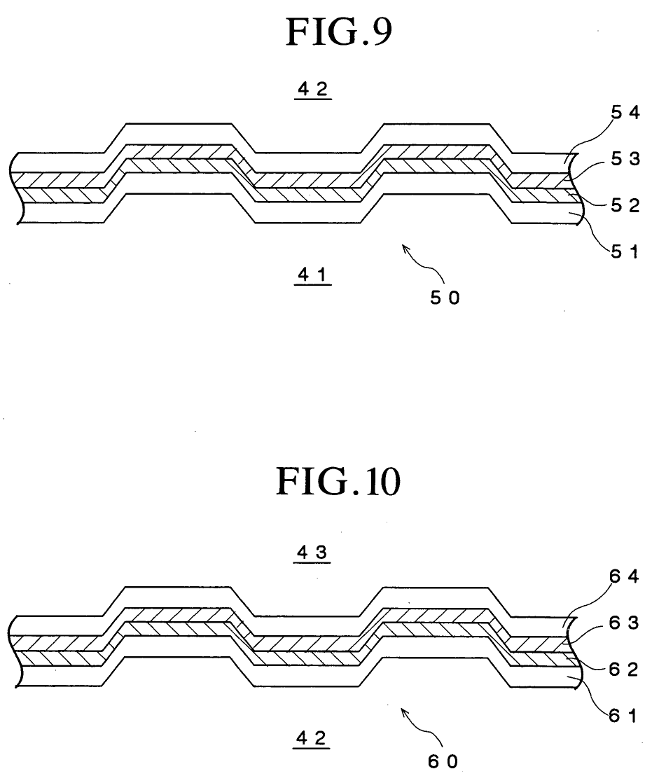

FIG. 9 is a schematic enlarged cross-sectional view showing details of the L0 information recording layer 50.

As shown in FIG. 9, the L0 information recording layer 50 is constituted by laminating a fourth dielectric film 51, a second L0 recording film 52, a first L0 recording film 53 and a third dielectric film 54 from the side of the support substrate 41.

In this embodiment, the first L0 recording film 53 contains Si as a primary component and the second L0 recording film 52 contains Cu as a primary component and 10 to 30 atomic % of Al as an additive.

FIG. 10 is a schematic enlarged cross-sectional view showing details of the L1 information recording layer 60.

As shown in FIG. 10, the L1 information recording layer 60 is constituted by laminating a second dielectric film 61, a second L1 recording film 62, a first L1 recording film 63 and a first dielectric film 64.

In this embodiment, the first L1 recording film 63 contains Si as a primary component and the second L1 recording film 62 contains Cu as a primary component and 10 to 30 atomic % of Al as an additive.

In the case where data are to be recorded in the L0 information recording layer 50 and data recorded in the L0 information recording layer 50 are to be reproduced, a laser beam L is projected thereon through the L1 information recording layer 60 located closer to the light incidence plane 43a.

Therefore, it is necessary for the L1 information recording layer 60 to have a high light transmittance with respect to the laser beam L used for recording data and reproducing data. Concretely, the L1 information recording layer 60 preferably has a light transmittance equal to or higher than 40% with respect to the laser beam L and more preferably has a light transmittance equal to or higher than 50%.

Each of the first dielectric film 64, the second dielectric film 61, the third dielectric film 54 and the fourth dielectric film 51 is formed of a similar material to those of the first dielectric layer 15 and the second dielectric layer 13 and in a similar manner of forming the first dielectric layer 15 and the second dielectric layer 13.

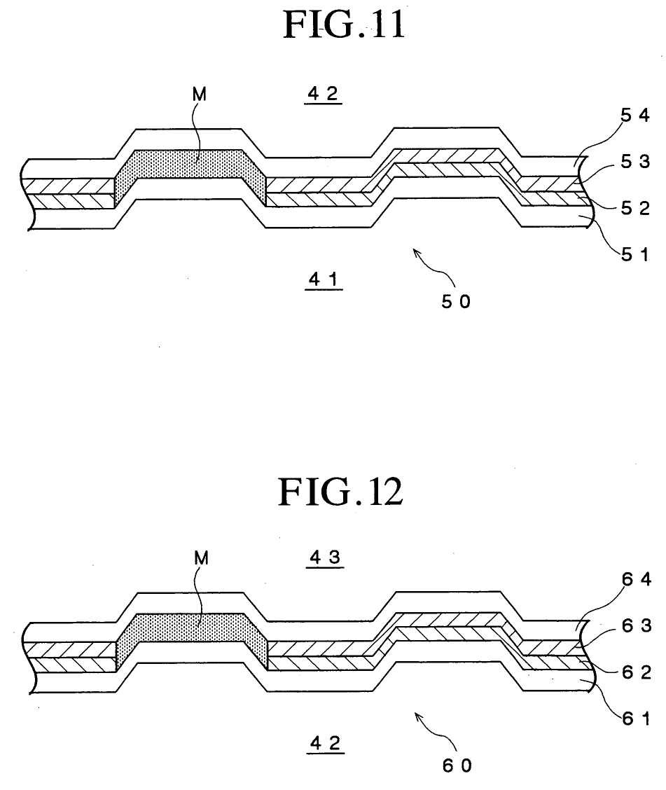

FIG. 11 is a schematic enlarged cross-sectional view showing the optical recording medium 30 shown in FIG. 8 after the L0 information recording layer 50 was irradiated with a laser beam L.

As shown in FIG. 11, when the L0 information recording layer 50 of the optical recording medium 30 is irradiated with a laser beam L via a light incident plane 43a, Si contained in the first L0 recording film 53 as a primary component and Cu contained in the second L0 recording film 52 as a primary component are quickly fused or diffused and a region where Si and Cu are mixed is formed, thereby forming a record mark M.

As shown in FIG. 11, when Si contained in the first L0 recording film 53 as a primary component and Cu contained in the second L0 recording film 53 as a primary component are mixed to form a record mark M, the reflection coefficient of a region where the record mark M has been formed greatly changes. Therefore, since the reflection coefficient of the region where the record mark M is formed is greatly different from that of the region of the L0 information recording layer 50 surrounding the region where the record mark M is formed, it is possible to obtain a high reproduced signal (C/N ratio) by reproducing data recorded in the L0 information recording layer 50.

FIG. 12 is a schematic enlarged cross-sectional view showing the optical recording medium 30 shown in FIG. 8 after the L1 information recording layer 60 was irradiated with a laser beam L.

As shown in FIG. 12, when the L1 information recording layer 60 of the optical recording medium 30 is irradiated with a laser beam L via a light incident plane 43a, Si contained in the first L1 recording film 63 as a primary component and Cu contained in the second L1 recording film 62 as a primary component are quickly fused or diffused and a region where Si and Cu are mixed is formed, thereby forming a record mark M.

As shown in FIG. 12, when Si contained in the first L1 recording film 63 as a primary component and Cu contained in the second L1 recording film 63 as a primary component are mixed to form a record mark M, the reflection coefficient of a region where the record mark M has been formed greatly changes. Therefore, since the reflection coefficient of the region where the record mark M is formed is greatly different from that of the region of the L1 information recording layer 60 surrounding the region where the record mark M is formed, it is possible to obtain a high reproduced signal (C/N ratio) by reproducing data recorded in the L1 information recording layer 60.

Since the laser beam L passes through the L1 information recording layer 60 when data are recorded in the L0 information recording layer 50 and when data are reproduced from the L0 information recording layer 50, it is necessary for the L1 information recording layer 60 to have a high light transmittance. However, the L1 information recording layer 60 having the above configuration has a light transmittance equal to or higher than 50 and it is therefore possible to record data in the L0 information recording layer 50.

Further, since the laser beam L passes through the L1 information recording layer 60 when data are recorded in the L0 information recording layer 50 and when data are reproduced from the L0 information recording layer 50, if the difference in light transmittances between a region of the L1 information recording layer 60 where a record mark M is formed and a blank region of the L1 information recording layer 60 where no record mark M is formed is great, the amount of the laser beam L projected onto the L0 information recording layer 50 when data are recorded in the L0 information recording layer 50 greatly changes depending upon whether the region of the L1 information recording layer 60 through which the laser beam L passes is a region where a record mark M is formed or a blank region and when data are reproduced from the L0 information recording layer 50, the amount of the laser beam L reflected from the L0 information recording layer 50, transmitting through the L1 information recording layer 60 and detected greatly changes depending upon whether the region of the L1 information recording layer 60 through which the laser beam L passes is a region where a record mark M is formed or a blank region. As a result, the recording characteristics of the L0 information recording layer 50 and the amplitude of a signal reproduced from the L0 information recording layer 50 change greatly depending upon whether the region of the L1 information recording layer 60 through which the laser beam L passes is a region where a record mark M is formed or a blank region.

In particular, data recorded in the L0 information recording layer 50 cannot be reproduced in a desired manner if the region of the L1 information recording layer 60 through which the laser beam L passes contains a boundary between a region where a record mark M is formed and a blank region, because in such a case the distribution of the reflection coefficient is not uniform at the spot of the laser beam L.

In a study done by the inventors of the present invention, it was found that in order to record data in the L0 information recording layer 50 and reproduce data from the L0 information recording layer 50, it is necessary for the difference in light transmittances between a region of the L1 information recording layer 60 where a record mark M is formed and a blank region of the L1 information recording layer 60 to be equal to or lower than 4% and it is preferable for the difference to be equal to or lower than 2%.

The inventors of the present invention further found that the difference in light transmittances for a laser beam having a wavelength of 350 nm to 450 nm between the region of a record mark M formed by mixing Si and Cu and a blank region of the L1 information recording layer 60 formed by laminating the first L1 recording film 63 containing Si as a primary component and the second L1 recording film 62 containing Cu as primary component is equal to or lower than 3% and the difference in light transmittances for a laser beam having a wavelength of about 405 nm between a region of the L1 information recording layer 60 where a record mark M is formed and a blank region of the L1 information recording layer 60 is equal to or lower than 1%.

Therefore, in this embodiment, when data are to be recorded in the L0 information recording layer 50, since the amount of the laser beam L projected onto the L0 information recording layer 50 hardly changes depending upon whether the region of the L1 information recording layer 60 through which the laser beam L passes is a region where a record mark M is formed or a blank region, the recording characteristics of the L0 information recording layer 50 can be markedly improved. Further, when data are reproduced from the L0 information recording layer 50, since the amount of the laser beam L reflected from the L0 information recording layer 50, transmitting through the L1 information recording layer 60 and detected hardly changes depending upon whether the region of the L1 information recording layer 60 through which the laser beam L passes is a region where a record mark M is formed or a blank region, it is possible to prevent the amplitude of a signal reproduced from the L0 information recording layer 50 from changing greatly depending upon whether the region of the L1 information recording layer 60 through which the laser beam L passes is a region where a record mark M is formed or a blank region.

Furthermore, according to this embodiment, when data recorded in the L0 information recording layer 50 are reproduced, even if the region of the L1 information recording layer 60 through which the laser beam L passes contains a boundary between a region where a record mark M is formed and a blank region, data recorded in the L0 information recording layer 50 can be reproduced in a desired manner.

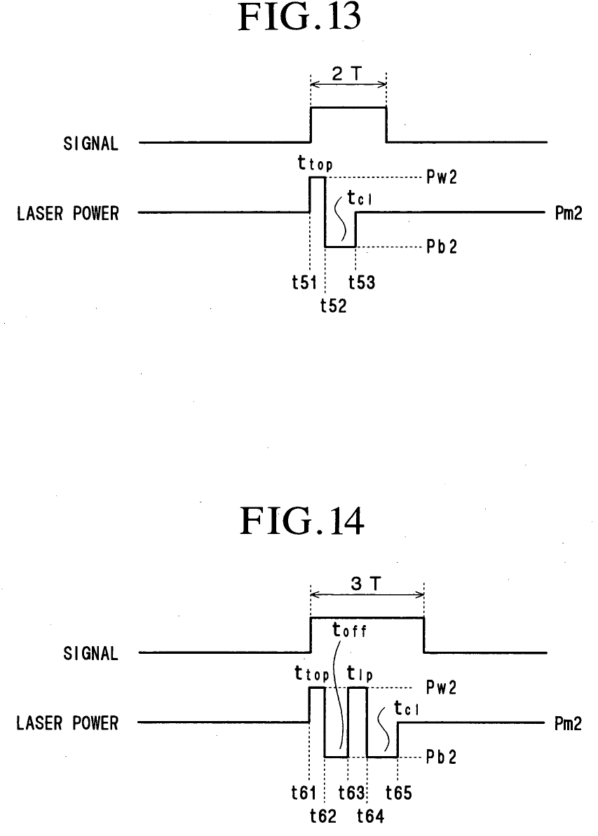

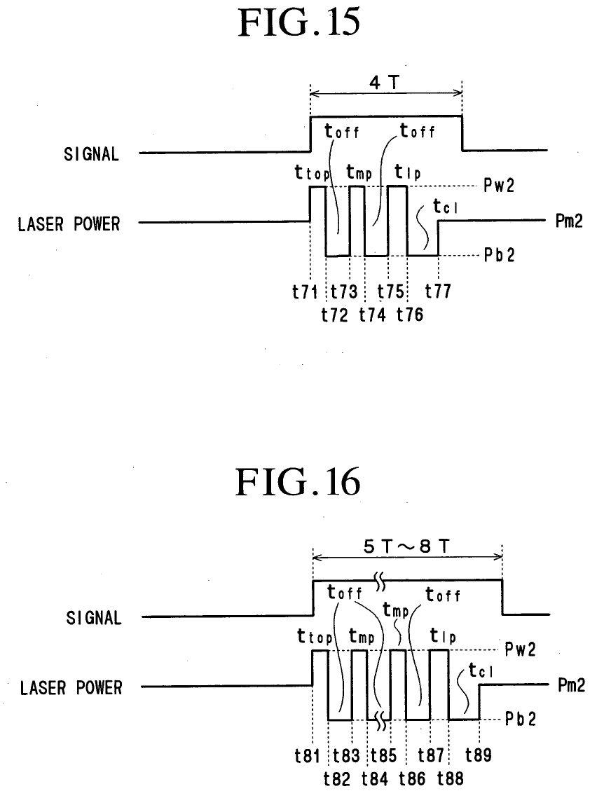

Each of FIGS. 13 to 16 is a diagram showing the waveform of a pulse train pattern for modulating the power of the laser beam L in the case of recording data in the L1 information recording layer 60 of the optical recording medium 40, where FIG. 13 shows a pulse train pattern used in the case of recording 2T signals, FIG. 14 shows a pulse train pattern used in the case of recording 3T signals, FIG. 15 shows a pulse train pattern used in the case of recording 4T signals and FIG. 16 shows a pulse train pattern used in the case of recording one among a 5T signal to an 8T signal.

As shown in FIGS. 13 to 16, the power of the laser beam L is modulated between three levels, a recording power Pw2, an intermediate power Pm2 and a ground power Pb2 where Pw2>Pm2>Pb2.

The recording power Pw2 is set to such a high level that Si contained in the first L1 recording film 63 as a primary component and Cu contained in the second L1 recording film 62 as a primary component can be heated and mixed to form a record mark M when the laser beam L whose power is set to the recording power Pw2 is projected onto the L1 information recording layer 60 and. On the other hand, the intermediate power Pm2 and the ground power Pb2 are set to such low levels that Si contained in the first L1 recording film 63 as a primary component and Cu contained in the second L1 recording film 62 as a primary component cannot be substantially mixed when the laser beam L whose power is set to the intermediate power Pm2 or the ground power Pb2 is projected onto the L1 information recording layer 60. In particular, the ground power Pb2 is set to such an extremely low level that regions of the L1 information recording layer 60 heated by irradiation with the laser beam L whose power is set to the recording power Pw2 can be cooled by irradiation with the laser beam L whose power is set to the ground power Pb2.

As shown in FIG. 13, in the case of recording 2T signals in the L1 information recording layer 60 of the optical recording medium 40, the power of the laser beam L is modulated so that it is increased from the intermediate power Pm2 to the recording power Pw2, decreased from the recording power Pw2 to the ground power Pb2 after passage of a predetermined time period tₜₒₚ, and increased from the ground power Pb2 to the intermediate power Pm2 after passage of a predetermined time period t_{cl}.

On the other hand, as shown in FIG. 14, in the case of recording 3T signals in the L1 information recording layer 60 of the optical recording medium 40, the power of the laser beam L is modulated so that it is increased from the intermediate power Pm2 to the recording power Pw2, decreased from the recording power Pw2 to the ground power Pb2 after passage of a predetermined time period tₜₒₚ, increased from the ground power Ph2 to the recording power Pw2 after passage of a predetermined time period t_{off}, decreased from the recording power Pw2 to the ground power Pb2 after passage of a predetermined time period tₗₚ, and increased from the ground power Pb2 to the intermediate power Pm2 after passage of a predetermined time period t_{cl}.

Further, as shown in FIG. 15, in the case of recording 4T signals in the L1 information recording layer 60 of the optical recording medium 40, the power of the laser beam L is modulated so that it is increased from the intermediate power Pm2 to the recording power Pw2, decreased from the recording power Pw2 to the ground power Pb2 after passage of a predetermined time period tₜₒₚ, increased from the ground power Pb2 to the recording power Pw2 after passage of a predetermined time period t_{off}, decreased from the recording power Pw2 to the ground power Pb2 after passage of a predetermined time period tₘₚ, increased from the ground power Pb2 to the recording power Pw2 after passage of a predetermined time period t_{off}, decreased from the recording power Pw2 to the ground power Pb2 after passage of a predetermined time period tₗₚ, and increased from the ground power Pb2 to the intermediate power Pm2 after passage of a predetermined time period t_{cl}.

Moreover, as shown in FIG. 16, in the case of recording one among a 5T signal to a 8T signal in the L1 information recording layer 60 of the optical recording medium 40, the power of the laser beam L is modulated so that it is increased from the intermediate power Pm2 to the recording power Pw2, held at the recording power Pw2 during the time period tₜₒₚ, the time periods tₘₚ and the time period tₗₚ, held at the ground power Pb2 during the time periods t_{off} and the time period t_{cl} and increased from the ground power Pb2 to the intermediate power Pm2 after passage of the time period t_{cl}.

In the case where data are recorded in the L1 information recording layer 60 of the optical recording medium 40 by modulating the power of a laser beam L using a pulse pattern shown in FIGS. 13 to 16, since the power of the laser beam L is modulated to the ground power Pb2 immediately after being set to the recording power Pw2, even when data are recorded in the L1 information recording layer 60 provided with no reflective film, it is possible to prevent excessive heat from being accumulated in the L1 information recording layer 60 and it is therefore possible to prevent the degradation of characteristics of signals obtained by reproducing data recorded in the L1 information recording layer 60 caused by heat generated in the first L1 recording film 63 and the second L1 recording film 62 even though the L1 information recording layer 60 includes no reflective film.

### WORKING EXAMPLES AND COMPARATIVE EXAMPLES

Hereinafter, working examples will be set out in order to further clarify the advantages of the present invention.

### Working Example 1

An optical recording medium sample # 1 was fabricated in the following manner.

A disk-like polycarbonate substrate having a thickness of 1.1 mm and a diameter of 120 mm and formed with grooves and lands on the surface thereof was first fabricated by an injection molding process so that the track pitch (groove pitch) was equal to 0.32 μm.

Then, the polycarbonate substrate was set on a sputtering apparatus and a second dielectric layer containing a mixture of ZnS and SiO₂ and having a thickness of 25 nm, a second recording film containing Cu as a primary component and 10 atomic % of Al as an additive and having a thickness of 5 nm, a first recording film containing Si as a primary component and having a thickness of 4 nm and a first dielectric film containing TiO₂ and having a thickness of 30 nm were sequentially formed on the surface of the polycarbonate substrate on which the grooves and lands were formed, using the sputtering process.

The mole ratio of ZnS to SiO₂ in the mixture of ZnS and SiO₂ contained in the second dielectric layer was 80:20.

Further, the polycarbonate substrate formed with the second dielectric layer, the second recording film, the first recording film and the first dielectric layer on the surface thereof was set on a spin coating apparatus and the first dielectric layer was coated using the spin coating method with a resin solution prepared by dissolving acrylic ultraviolet ray curable resin in a solvent to form a coating layer and the coating layer was irradiated with ultraviolet rays, thereby curing the acrylic ultraviolet ray curable resin to form a light transmission layer having a thickness of 100 μm.

Thus, the optical recording medium sample #1 was fabricated.

The optical recording medium sample #1 was set in an optical recording medium evaluation apparatus “DDU1000” (Product Name) manufactured by Pulstec Industrial Co., Ltd. and a laser beam which has a wavelength of 405 nm and whose power was modulated using a pulse train pattern shown in FIG. 16 was focused onto the first recording film and the second recording film using an objective lens whose numerical aperture was 0.85 via the light transmission layer while the optical recording medium sample # 1 was rotated at a linear velocity of 5.3 m/sec, thereby recording random signals including 2T signals to 8T signals in the 1,7 RLL Modulation Code therein.

The pulse widths of the pulse train pattern were set so that tₜₒₚ was equal to 0.5 T, tₘₚ and tₗₚ were equal to 0.4 T and t_{cl} was equal to 1.2 T.

The random signals were recorded in the optical recording medium sample # 1 by setting the recording power Pw2 of the laser beam to 7.0 mW, while the intermediate power Pm2 was fixed at 2.4 mW and the ground power of the laser beam was fixed at 0.1 mW.

Then, the optical recording medium sample # 1 was set in the above mentioned optical recording medium evaluation apparatus and a laser beam having a wavelength of 405 nm was focused onto the first recording film and the second recording film using an objective lens whose numerical aperture was 0.85 via the light transmission layer while the optical recording medium sample # 1 was rotated at a linear velocity of 5.3 m/sec, thereby reproducing a signal recorded in the optical recording medium sample # 1 and clock jitter of the reproduced was measured, thereby measuring the lowest clock jitter.

The fluctuation σ of a reproduced signal was measured using a time interval analyzer and the clock jitter was calculated as σ/Tw, where Tw was one clock period.

Then, similarly to the above, random signals were recorded in the optical recording medium sample # 1 while increasing the recording power Pw2 of the laser beam in increments of 0.2 mW up to 10.0 mw and signals reproduced from the optical recording medium sample # 1 similarly to the above were measured.

The lowest clock jitter was determined from among the thus measured clock jitters and the recording power Pw2 at which the clock jitter of the reproduced signal was lowest was determined as an optimum recording power of the laser beam.

Further, the optical recording medium samples # 1 were re-fabricated with the thickness of the first dielectric layer increased in increments of 1 nm up to 33 nm and, similarly to the above, random signals were recorded in each of the optical recording medium samples # 1 while varying the recording power Pw2 of the laser beam in increments of 0.2 mW within the range of 6.0 mW to 10.0 mW. Then, a signal was reproduced from each of the optical recording medium samples # 1 similarly to the above and the lowest clock jitter was obtained, thereby determining the recording power Pw2 at which the clock jitter of a reproduced signal was lowest as an optimum recording power of the laser beam of each of optical recording medium samples # 1.

Then, the minimum value of the clock jitter among the thus obtained clock jitters of the optical recording medium samples # 1 was determined as the minimum clock jitter of the optical recording medium sample # 1 and the recording power Pw2 at which the minimum clock jitter was obtained was determined as an optimum recording power of the optical recording medium sample # 1.

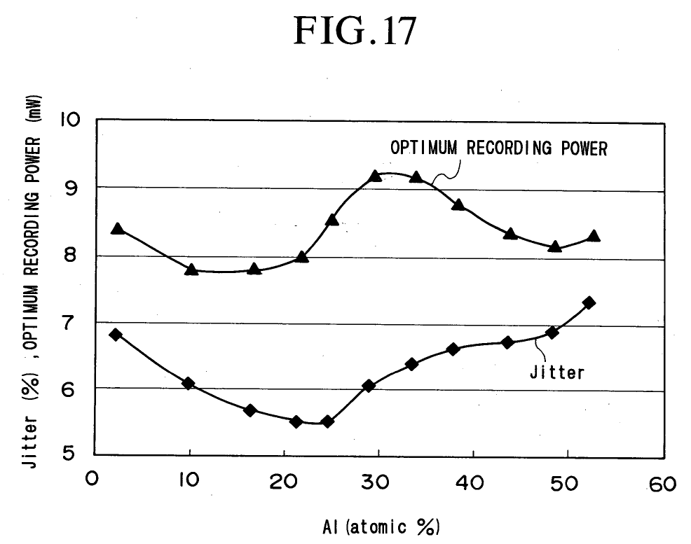

The results of the measurement are shown in FIG. 17.

Further, optical recording medium samples # 2 to #11 were sequentially fabricated in the manner of fabricating the optical recording medium sample #1 except that the amount of Al added to the second recording film of each sample was varied within a range of 2 atomic % to 53 atomic % and the thickness of the first dielectric layer was varied within a range of 30 nm to 33 nm.

Each of the optical recording medium samples # 2 formed with the first dielectric layers having different thicknesses was set in the above mentioned optical recording medium evaluation apparatus and random signals were recorded in each the optical recording medium samples # 2 in the manner of recording the random signals in the optical recording medium sample #1.

The random signals were recorded in each of the optical recording medium samples # 2 with the recording power Pw2 of the laser beam set at 6.0 mW, while the intermediate power Pm2 was fixed at 2.4 mW and the ground power of the laser beam was fixed at 0.1 mW.

Then, each of the optical recording medium samples # 2 was set in the above mentioned optical recording medium evaluation apparatus and a signal recorded in each of the optical recording medium samples # 2 was reproduced in the manner of reproducing the signal from the optical recording medium sample #1 and clock jitter of the reproduced signal was measured.

Further, similarly to in the optical recording medium samples # 1, random signals were recorded in each of the optical recording medium samples # 2 by increasing the recording power Pw2 of the laser beam in increments of 0.2 mW up to 10.0 mW and clock jitter of a signal reproduced from each sample was measured.

Then, the lowest clock jitter of each of the optical recording medium samples # 2 was determined from among the thus measured clock jitters of the signal reproduced from each sample and the recording power Pw2 at which the clock jitter of a reproduced signal was lowest was determined as an optimum recording power of the laser beam of each of the optical recording medium samples # 2.

Then, the minimum value of the clock jitter among the thus obtained clock jitters of the optical recording medium samples # 2 was determined as the minimum clock jitter of the optical recording medium sample # 2 and the recording power Pw2 at which the minimum clock jitter was obtained was determined as an optimum recording power of the optical recording medium sample # 2.

The results of the measurement are shown in FIG. 17.

Similarly to in the optical recording medium sample # 1 and # 2, the minimum clock jitter and an optimum recording power of each of the optical recording medium samples # 3 to # 11 were determined.

The results of the measurement are shown in FIG. 17.

As shown in FIG. 17, it was found that in the case where the amount of Al added to the second recording film was 10 atomic % to 30 atomic %, jitter of the reproduced signal was equal to or lower than 6%, i.e., jitter could be sufficiently reduced, and it was further found that in the case where the amount of Al added to the second recording film was 20 atomic % to 25 atomic %, jitter of the reproduced signal could be markedly reduced.

Moreover, as shown in FIG. 17, it was found that in the case where the amount of Al added to the second recording film was equal to or less than 25 atomic %, the optimum recording power of the laser beam was equal to or lower than 8.5 mW and the recording sensitivity was improved, and it was further found that in the case where the amount of Al added to the second recording film was 10 atomic % to 20 atomic %, the optimum recording power of the laser beam was equal to or lower than 8.0 mW and the recording sensitivity was markedly improved.

### Working Example 2

Each of the optical recording medium samples #1 to #11 was irradiated with a laser beam having a wavelength of 405 nm and the amount of the laser beam transmitted through each of the optical recording medium samples #1 to #11 was measured, thereby measuring the light transmittance of each sample.

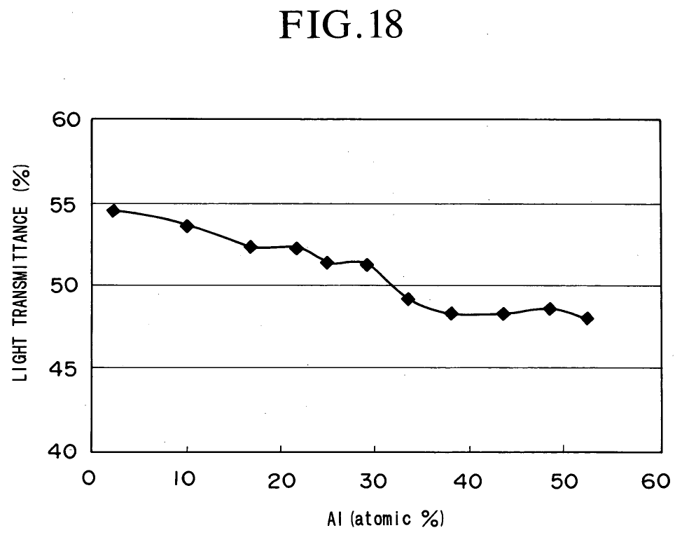

The results of the measurement are shown in FIG. 18.

As shown in FIG. 18, it was found that the optical recording samples in which the amount of Al added to the second recording film was 10 atomic % to 30 atomic % had light transmittances equal to or higher than 50%, i.e., they had sufficiently high light transmittances.

The present invention has thus been shown and described with reference to specific embodiments and working examples. However, it should be noted that the present invention is in no way limited to the details of the described arrangements but changes and modifications may be made without departing from the scope of the appended claims.

For example, in the embodiment shown in FIG. 8, although the optical recording medium 40 includes the L0 information recording layer 50 and the L1 information recording layer 50 as information recording layers, it is not absolutely necessary for the optical recording medium 40 to include the L0 information recording layer 50 and the L1 information recording layer 60 as information recording layers and the optical recording medium may include three or more information recording layers.

Moreover, in the embodiment shown in FIG. 8, although the L0 information recording layer 50 is constituted by laminating the fourth dielectric film 51, the second L0 recording film 52, the first L0 recording film 53 and the third dielectric film 54 from the side of the support substrate 41, the L0 information recording layer 50 may include a reflective film between the support substrate 11 and the fourth dielectric film 51. In such a case, the reflective film may be formed of Mg, Al, Ti, Cr, Fe, Co, Ni, Cu, Zn, Ge, Ag, Pt, Au and the like, and among these materials, it is preferable to form the reflective film of a metal material having a high reflection characteristic, such as Al, Au, Ag, Cu or alloy containing at least one of these metals, such as alloy of Al and Ti.

Further, in the embodiment shown in FIGS. 1 and 2, although the first recording film 31 and the second recording film 32 of the recording layer 14 are formed in contact with each other it is not absolutely necessary to form the first recording film 31 and the second recording film 32 of the recording layer 14 in contact with each other but it is sufficient for the second recording film 32 to be so located in the vicinity of the first recording film 31 as to enable formation of a mixed region including the primary component element of the first recording film 31 and the primary component element of the second recording film 32 when the region is irradiated with a laser beam. Further, one or more other films such as a dielectric film may be interposed between the first recording film 31 and the second recording film 32.

Furthermore, in the embodiment shown in FIG. 8, although the first L1 recording film 63 and the second L1 recording film 62 of the L1 information recording layer 60 are formed in contact with each other it is not absolutely necessary to form the first L1 recording film 63 and the second L1 recording film 62 of the L1 information recording layer 60 in contact with each other but it is sufficient for the second L1 recording film 62 to be so located in the vicinity of the first L1 recording film 63 as to enable formation of a mixed region including the primary component element of the first L1 recording film 63 and the primary component element of the second L1 recording film 62 when the region is irradiated with a laser beam. Further, one or more other films such as a dielectric film may be interposed between the first L1 recording film 63 and the second L1 recording film 62.

Moreover, in the embodiment shown in FIG. 8, although the first L0 recording film 53 and the second L0 recording film 52 of the L0 information recording layer 50 are formed in contact with each other it is not absolutely necessary to form the first L0 recording film 53 and the second L0 recording film 52 of the L0 information recording layer 50 in contact with each other but it is sufficient for the second L0 recording film 52 to be so located in the vicinity of the first L0 recording film 53 as to enable formation of a mixed region including the primary component element of the first L0 recording film 53 and the primary component element of the second L0 recording film 52 when the region is irradiated with a laser beam. Further, one or more other films such as a dielectric film may be interposed between the first L0 recording film 53 and the second L0 recording film 52.

Further, in the embodiment shown in FIG. 8, although the optical recording medium 40 includes the L0 information recording layer 50, it is not absolutely necessary for the optical recording medium 40 to include the L0 information recording layer 50 and instead of the L0 information recording layer 50, the support substrate 41 or the transparent intermediate layer 42 can be utilized as a recording layer adapted to enable only data reading by forming pits on the surface of the support substrate 41 or the transparent intermediate layer 42 and recording data therein.

Furthermore, in the embodiment shown in FIGS. 1 and 2, although the first recording film 31 of the recording layer 14 contains Si as a primary component, it is not absolutely necessary for the first recording film 31 of the recording layer 14 to contain Si as a primary component and the first recording film 31 of the recording layer 14 may contain an element selected from the group consisting of Ge, Sn, Mg, In, Zn, Bi and Al instead of Si.

Moreover, in the embodiment shown in FIG. 8, although each of the second L0 recording film 53 and the second L1 recording film 63 contains Cu as a primary component, it is not absolutely necessary for each of the second L0 recording film 53 and the second L1 recording film 63 to contain Cu as a primary component and each of the second L0 recording film 53 and the second L1 recording film 63 may contain an element selected from the group consisting of Al, Zn, Ti and Ag instead of Cu.

Further, in the embodiment shown in FIGS. 1 and 2, although the first recording film 31 is disposed on the side of the light transmission layer 16 and the second recording film 32 is disposed on the side of the support substrate 11, it is possible to dispose the first recording film 31 on the side of the support substrate 11 and the second recording film 32 on the side of the light transmission layer 16.

Furthermore, in the embodiment shown in FIG. 8, although the first L0 recording film 53 is disposed on the side of the light transmission layer 43 and the second L0 recording film 52 is disposed on the side of the support substrate 41, it is possible to dispose the first L0 recording film 53 on the side of the support substrate 41 and the second L0 recording film 52 on the side of the light transmission layer 43.

Moreover, in the embodiment shown in FIG. 8, although the first L1 recording film 63 is disposed on the side of the light transmission layer 43 and the second L1 recording film 62 is disposed on the side of the support substrate 41, it is possible to dispose the first L1 recording film 63 on the side of the support substrate 41 and the second L1 recording film 62 on the side of the light transmission layer 43.

Further, in the embodiment shown in FIGS. 1 and 2, although the reflective layer 12 is provided on the support substrate 11, in order to prevent the reflective layer 12 from being corroded, it is possible to form a moisture-proof layer between the support substrate 11 and the reflective layer 12.

Furthermore, in the embodiment shown in FIGS. 1 and 2, although the optical recording medium 10 includes the reflective layer 12 and it is preferable to provide the reflective layer 12 in order to obtain a higher reproduced signal (C/N ratio) by a multiple interference effect, it is not absolutely necessary for the optical recording medium 10 to include the reflective layer 12.

Moreover, in the embodiment shown in FIG. 8, although the L1 information recording layer 60 includes no reflective film, the L1 information recording layer 60 may include a thin reflective film.

Furthermore, the optical recording medium 10 includes the light transmission layer 16 and is constituted so that a laser beam L is projected onto the recording layer 14 via the light transmission layer 16 in the embodiment shown in FIGS. 1 and 2 and the optical recording medium 40 includes the light transmission layer 43 and is constituted so that a laser beam L is projected onto the L0 information recording layer 50 or the L1 information recording layer 60 via the light transmission layer 43 in the embodiment shown in FIG. 8. However, the present invention is not limited to an optical recording medium having such a configuration and the optical recording medium may include a substrate formed of a light transmittable material and be constituted so that a laser beam L is projected onto the recording layer 14 or the L0 information recording layer 50 or the L1 information recording layer 60 via the substrate.

According to the present invention, it is possible to provide an optical recording medium which has an excellent initial recording characteristic and can store recorded data in a good condition over the long term.

1. An optical recording medium comprising a substrate and a recording layer in which data can be recorded by projecting a laser beam thereonto, the recording layer including a first recording film containing an element selected from the group consisting of Si, Ge, Sn, Mg, In, Zn, Bi and Al as a primary component and a second recording film containing Cu as a primary component and 10 to 30 atomic % of Al as an additive.

2. An optical recording medium in accordance with claim 1, wherein the second recording film is formed so as to be in contact with the first recording film.

3. An optical recording medium in accordance with claim 1, wherein the second recording film contains 10 to 25 atomic % of Al.

4. An optical recording medium in accordance with claim 3, wherein the second recording film contains 20 to 25 atomic % of Al.

5. An optical recording medium in accordance with claim 1, which further comprises a first dielectric layer and a second dielectric layer on the both sides of the recording layer.

6. An optical recording medium in accordance with claim 2, which further comprises a first dielectric layer and a second dielectric layer on the both sides of the recording layer.

7. An optical recording medium in accordance with claim 3, which further comprises a first dielectric layer and a second dielectric layer on the both sides of the recording layer.

8. An optical recording medium in accordance with claim 4, which further comprises a first dielectric layer and a second dielectric layer on the both sides of the recording layer.

9. An optical recording medium in accordance with claim 1, which further comprises a light transmission layer having a thickness of 10 to 300 μm on the opposite side to the substrate with respect to the recording layer and one surface of the light transmission layer constitutes a light incidence plane through which the laser beam enters the optical recording medium.

10. An optical recording medium in accordance with claim 1, wherein the laser beam has a wavelength of 380 nm to 450 nm.

11. An optical recording medium comprising a substrate and a plurality of information record layers in which data can be recorded by projecting a laser beam thereonto, at least one information recording layer other than a information recording layer farthest from a light incidence plane through which a laser beam enters including a first recording film containing an element selected from the group consisting of Si, Ge, Sn, Mg, In, Zn, Bi and Al as a primary component and a second recording film containing Cu as a primary component and 10 to 30 atomic % of Al as an additive.

12. An optical recording medium in accordance with claim 11, wherein the second recording film is formed so as to be in contact with the first recording film.

13. An optical recording medium in accordance with claim 11, wherein the second recording film contains 10 to 25 atomic % of Al.

14. An optical recording medium in accordance with claim 13, wherein the second recording film contains 20 to 25 atomic % of Al.

15. An optical recording medium in accordance with claim 11, which further comprises a light transmission layer having a thickness of 10 to 300 μm on the opposite side to the substrate with respect to the recording layer and one surface of the light transmission layer constitutes a light incidence plane through which the laser beam enters the optical recording medium.

16. An optical recording medium in accordance with claim 12, which further comprises a light transmission layer having a thickness of 10 to 300 μm on the opposite side to the substrate with respect to the recording layer and one surface of the light transmission layer constitutes a light incidence plane through which the laser beam enters the optical recording medium.

17. An optical recording medium in accordance with claim 13, which further comprises a light transmission layer having a thickness of 10 to 300 μm on the opposite side to the substrate with respect to the recording layer and one surface of the light transmission layer constitutes a light incidence plane through which the laser beam enters the optical recording medium.

18. An optical recording medium in accordance with claim 14, which further comprises a light transmission layer having a thickness of 10 to 300 μm on the opposite side to the substrate with respect to the recording layer and one surface of the light transmission layer constitutes a light incidence plane through which the laser beam enters the optical recording medium.

19. An optical recording medium in accordance with claim 11, wherein the laser beam has a wavelength of 380 nm to 450 nm.
